(19) United States
(12) Patent Application Publication
(10) Pub. No.: US 2026/0179309 A1
(43) Pub. Date: Jun. 25, 2026

(54) ELECTRONIC DEVICE TO CONTROL TO DISPLAY VIRTUAL SPACE, CONTROL METHOD THEREFOR, AND MEDIUM STORING CONTROL PROGRAM THEREFOR

(71) Applicant: CANON KABUSHIKI KAISHA, Tokyo (JP)

(72) Inventor: MASATAKA IKAWA, Kanagawa (JP)

(21) Appl. No.: 19/413,545

(22) Filed: Dec. 9, 2025

(30) Foreign Application Priority Data
Dec. 23, 2024 (JP) 2024-226484

(51) Int. Cl. G06T 15/10

(52) U.S. Cl. CPC G06T 15/10; G06T 2200/24

(57) ABSTRACT

An electronic device performs control to display on a display device a list screen of one or more images or a browsing screen of an image selected by a user from among the one or more images, acquires position information associated with the image selected by the user, and performs control in response to a predetermined user operation while the list screen or the browsing screen is displayed so that display on the display device is switched from display of the list screen or the browsing screen to display of a video of a virtual space having a viewpoint from a position corresponding to the position information, in a case where the position information is acquired.

### BACKGROUND

### Field of the Technology

The present disclosure relates to an electronic device, and particularly, to a technique for displaying an image or the like posted on a social networking service (SNS).

### Description of the Related Art

A user of an SNS can post a photograph or the like captured at an attraction spot or the like visited by the user so that other users can view the photograph or the like. Users of the SNS may obtain information on an attraction spot or the like by viewing the posted photograph and may determine their destination.

A digital twin space that reproduces a real space has been proposed as a virtual space to be experienced by (provided to) a user via a display device such as a head mounted display (HMD). By providing the digital twin space to the user, the user can visit an attraction spot in a pseudo manner.

Japanese Patent Laid-Open No. 2004-029937 discloses displaying a 3D image prepared in advance when reserving an accommodation or the like. Japanese Patent Laid-Open No. 2024-048107 discloses a technique for recommending a place in the real world based on a behavior history of a user in a metaverse.

However, because an angle of view of a two-dimensional (2D) photograph is limited, the user cannot obtain sufficient information only by viewing the 2D photograph and may not be able to suitably determine their destination. When the technique disclosed in Japanese Patent Laid-Open No. 2004-029937 is used, a user can view a three-dimensional (3D) image related to an accommodation or the like, but the angle of view of the 3D image is also limited and the user cannot obtain sufficient information. The user can obtain sufficient information by moving to a capturing position of the photograph in the digital twin space, but such movement is not easy.

### SUMMARY

The present disclosure provides a technique through which a user can easily obtain information on a portion not drawn in an image (for example, a portion not shown in a photograph).

An electronic device according to the present disclosure includes a processor, and a memory storing a program which, when executed by the processor, causes the electronic device to execute acquisition processing of acquiring position information associated with an image selected by a user from among one or more images, and execute control processing of performing control so that a video of a virtual space having a viewpoint from a position corresponding to the position information is displayed on a display device in a case where the position information is acquired by the acquisition processing, wherein in the control processing, control is performed to display on the display device a list screen of the one or more images or a browsing screen of the image selected by the user, and control is performed in response to a first user operation while the list screen or the browsing screen is displayed so that display on the display device is switched from display of the list screen or the browsing screen to display of the video of the virtual space.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration of an information processing system.

FIG. 2 is a block diagram illustrating a configuration of an HMD, a PC, and a controller.

FIG. 3 is a flowchart illustrating processing of the PC.

FIGS. 4A to 4E are schematic diagrams each illustrating an example of a list screen.

FIGS. 5A and 5B are schematic diagrams each illustrating an example of a browsing screen.

FIGS. 6A to 6D are schematic diagrams each illustrating an example of a virtual space video.

### DESCRIPTION OF THE EMBODIMENTS

Hereinafter, embodiments of the present disclosure will be described with reference to the accompanying drawings. Note that the following embodiments do not limit the scope of the claims. Although a plurality of features are described in the embodiments, not all of the plurality of features are essential, and the plurality of features may be freely combined. In the accompanying drawings, the same or similar configurations are denoted by the same reference numerals, and redundant description will be omitted.

### Configuration of System

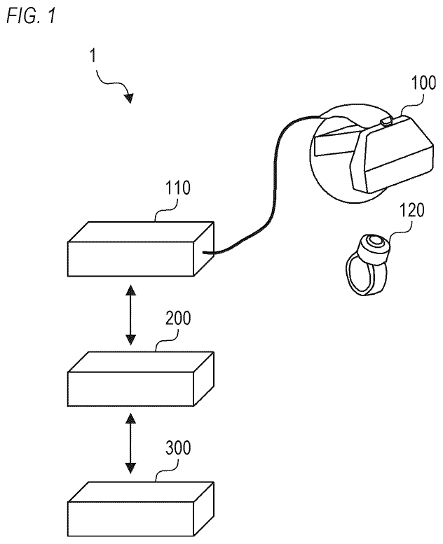

FIG. 1 is a schematic diagram illustrating a configuration of an information processing system 1 according to the present embodiment. The information processing system 1 includes a head mounted display (HMD) 100, a personal computer (PC) 110, and a controller 120. The information processing system 1 includes a social networking service (SNS) server 200 and a virtual space server 300. It is assumed that the HMD 100, the PC 110, and the controller 120 are separate devices, but two or three of the HMD 100, the PC 110, or the controller 120 may be integrated as one device.

The HMD 100 is a display device (a head mounted display device) wearable on the head of a user. The HMD 100 displays an image received from the PC 110.

The PC 110 is connected to the HMD 100 and controls the HMD 100. A connection between the PC 110 and the HMD 100 may be a wired connection using a USB cable or the like or may be a wireless connection using Bluetooth (registered trademark), Wireless Fidelity (Wi-Fi) (registered trademark), or the like. Each component of the PC 110 may be provided in the HMD 100. An electronic device capable of controlling the HMD 100 is not limited to the PC, and may be, for example, a smartphone, a tablet terminal, or the like.

The controller 120 is connected to the PC 110 and transmits an operation signal to the PC 110 in response to a user operation on the controller 120. The PC 110 performs various types of control such as control of the HMD 100 according to an operation signal received from the controller 120. A connection between the controller 120 and the PC 110 may be a wired connection using a USB cable or the like or may be a wireless connection using Bluetooth (registered trademark), Wireless Fidelity (Wi-Fi) (registered trademark), or the like. The controller 120 may be in communication with the HMD 100. A plurality of controllers may be used for one PC 110 (or one HMD 100).

As illustrated in FIG. 1, the controller 120 is a ring-type device wearable and supportable on the finger of a user. The user can instruct a position on a video (a screen) displayed on the HMD 100 by using the controller 120 and change the instruction position by moving the controller 120. On the HMD 100, a point indicating the instruction position is displayed, or a virtual light beam (ray) that is a straight line (a line segment) extending from the controller 120 to the instruction position is displayed. The controller 120 is provided with a physical button, and the user can perform a menu determination operation or a menu selection operation by pressing the button.

Note that the controller 120 is not limited to the ring-type device, and may be, for example, a hand-held-type device held by the hand, a bracelet-type device worn on the arm, or a glove-type device such as a glove. An operation member provided on the controller 120 is not limited to the button and may include any one or a plurality of a track pad, a touch panel, a wheel, or a track ball. The operation that can be received by the controller 120 is not limited to pressing of the button, and may include a sliding operation, a flick operation, a touch operation, and the like. The controller 120 may be attached to a hand-held object or the like.

The SNS server 200 receives posts including content such as images, music, and comments from various users, and provides the posted content to various users. For example, the SNS server 200 receives a post of an image from the PC 110 and transmits a posted image to the PC 110. Note that the SNS server 200 also receives posts including content such as images, music, and comments from other electronic devices such as a smartphone or a tablet terminal from various users. The SNS server 200 also provides the posted content to the other electronic devices such as various smartphones and tablet terminals.

The virtual space server 300 provides a virtual space to various users. For example, the virtual space server 300 transmits data of the virtual space (for example, data representing a three-dimensional (3D) model of the virtual space) to the PC 110 via the SNS server 200. The virtual space server 300 may communicate with the PC 110 without passing through the SNS server 200. The virtual space is, for example, a digital twin space that is a three-dimensional space reproducing a real space. The virtual space is not limited to the digital twin space, and may be, for example, a metaverse space other than the digital twin space.

### Configuration of HMD

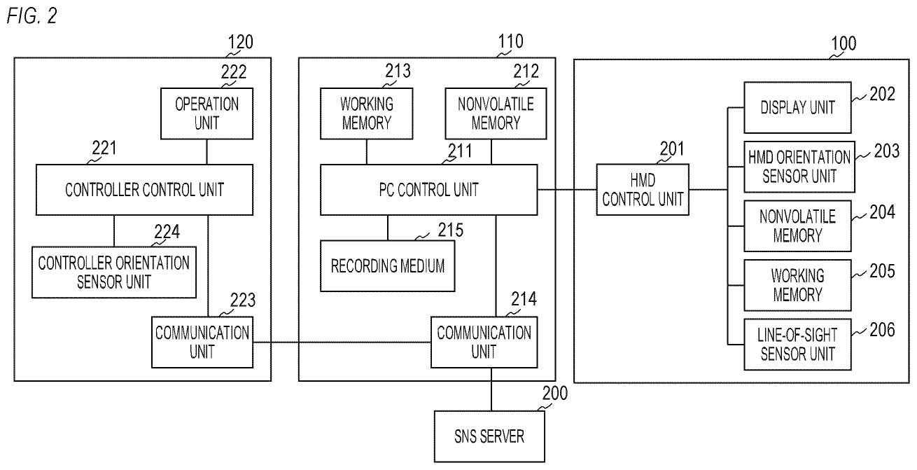

FIG. 2 is a block diagram illustrating a configuration of the HMD 100, the PC 110, and the controller 120. The HMD 100 includes an HMD control unit 201, a display unit 202, an HMD orientation sensor unit 203, a nonvolatile memory 204, a working memory 205, and a line-of-sight sensor unit 206.

The HMD control unit 201 is, for example, a CPU, and controls each unit of the HMD 100. Upon receiving an image (image data) from the PC 110, the HMD control unit 201 displays the image on the display unit 202. Note that, instead of the HMD control unit 201 controlling the entire HMD 100, a plurality of pieces of hardware may share processing and control the entire HMD 100.

The display unit 202 displays an image. For example, the display unit 202 includes a display panel such as a liquid crystal panel or an organic EL panel and displays an image on the display panel. While the HMD 100 is worn by a user, the display unit 202 is disposed in front of the user's eyes. The display unit 202 includes a right display unit disposed in front of the right eye and a left display unit disposed in front of the left eye and displays two images having parallax on each of the right display unit and the left display unit so that the user can stereoscopically view the image.

The HMD orientation sensor unit 203 acquires information on an orientation (and a position) of the HMD 100. The HMD orientation sensor unit 203 may acquire information on an orientation (and a position) of the user (the user wearing the HMD 100) corresponding to the orientation (and the position) of the HMD 100. The HMD control unit 201 transmits information acquired by the HMD orientation sensor unit 203 (information on the orientation (and the position)) to the PC 110. The HMD orientation sensor unit 203 includes, for example, an inertial measurement unit (IMU). The IMU includes at least one of an acceleration sensor, an angular acceleration sensor, a magnetic sensor (including a geomagnetic sensor), and an ultrasonic sensor.

The nonvolatile memory 204 is an electrically erasable and recordable nonvolatile memory. The nonvolatile memory 204 stores programs and the like to be executed by the HMD control unit 201.

The working memory 205 is used as a buffer memory that temporarily stores various types of data, an image display memory of the display unit 202, a work area of the HMD control unit 201, and the like.

The line-of-sight sensor unit 206 acquires information for detecting a line of sight of the user. For example, the line-of-sight sensor unit 206 includes a camera (an image sensor) that captures an image of the eye of the user wearing the HMD 100. The HMD control unit 201 transmits information acquired by the line-of-sight sensor unit 206 to the PC 110 (for example, the image obtained by capturing the eye of the user).

### Configuration of Controller

As illustrated in FIG. 2, the controller 120 includes a controller control unit 221, an operation unit 222, a communication unit 223, and a controller orientation sensor unit 224.

The controller control unit 221 is, for example, a CPU, and controls each unit of the controller 120. Note that, instead of the controller control unit 221 controlling the entire controller 120, a plurality of pieces of hardware may share processing and control the entire controller 120.

The operation unit 222 includes an operation member such as a button and detects a user operation such as pressing of the button. Upon detecting a user operation, the operation unit 222 transmits an operation signal corresponding to the user operation to the PC 110 via the communication unit 223.

The communication unit 223 communicates with the PC 110.

The controller orientation sensor unit 224 acquires information on an orientation (and a position) of the controller 120. The controller orientation sensor unit 224 transmits the acquired information (information on the orientation (and the position)) to the PC 110 via the communication unit 223. The controller orientation sensor unit 224 includes, for example, an IMU including at least one of an acceleration sensor, an angular acceleration sensor, a magnetic sensor (including a geomagnetic sensor), and an ultrasonic sensor.

### Configuration of PC

As illustrated in FIG. 2, the PC 110 includes a PC control unit 211, a nonvolatile memory 212, a working memory 213, a communication unit 214, and a recording medium 215.

The PC control unit 211 is, for example, a CPU, and controls each unit of the PC 110. Note that, instead of the PC control unit 211 controlling the entire PC 110, a plurality of pieces of hardware may share processing and control the entire PC 110.

The PC control unit 211 transmits to the HMD 100 an image (image data) to be displayed on the HMD 100. The PC control unit 211 can also generate a video (video data) of the virtual space and transmit the video to the HMD 100. Here, the PC control unit 211 determines a range of the virtual space to be generated as a video based on the information acquired by the HMD orientation sensor unit 203 (information on the orientation (and the position) of the HMD 100). Accordingly, the range of the virtual space to be displayed can be changed depending on a change in the position and the orientation of the HMD 100 (user) as if the user is in the virtual space.

The PC control unit 211 combines (superimposes) an item (a point, a ray, or the like) indicating the instruction position of the user with an image to be displayed on the HMD 100 based on information acquired by the controller orientation sensor unit 224 (information on the orientation (and the position) of the controller 120).

The PC control unit 211 performs various types of control in response to an operation signal transmitted from the operation unit 222. The PC control unit 211 detects a line of sight of the user wearing the HMD 100 based on information acquired by the line-of-sight sensor unit 206 (for example, the image obtained by capturing the eye of the user), and performs various types of control based on the line of sight of the user. For example, the PC control unit 211 regards the user gazing at the button displayed on the HMD 100 as the user pressing the button and performs various types of control.

The nonvolatile memory 212 is an electrically erasable and recordable nonvolatile memory. The nonvolatile memory 212 stores programs and the like to be executed by the PC control unit 211.

The working memory 213 is used as a buffer memory that temporarily stores various types of data, an image display memory of the display unit 202, a work area of the PC control unit 211, and the like.

The communication unit 214 communicates with the controller 120, the SNS server 200, and the like.

The recording medium 215 stores various types of data.

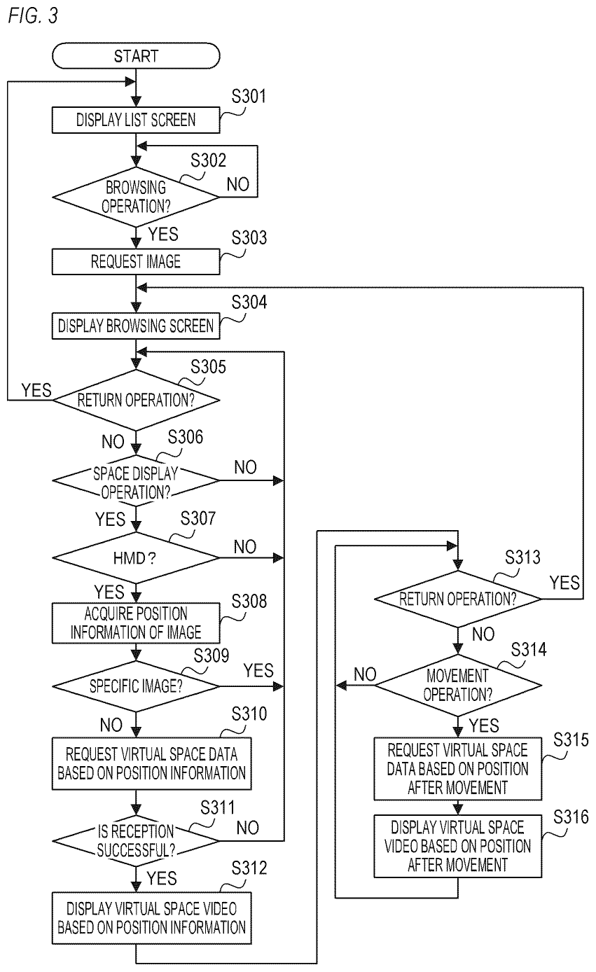

FIG. 3 is a flowchart illustrating processing of the PC 110. The processing in FIG. 3 is implemented by the PC control unit 211 that loads a program stored in the nonvolatile memory 212 into the working memory 213 and executes the program. For example, when the PC 110 is activated and a user operation of activating an SNS application installed on the PC 110 is performed, the processing in FIG. 3 starts. During activation of the SNS application, the processing in FIG. 3 is repeatedly performed at a predetermined cycle. When a user operation of ending the SNS application is performed, the processing in FIG. 3 ends.

In step S301, the PC control unit 211 displays a list screen of content posted on the SNS server 200 on a display device connected to the PC 110 (in the present embodiment, the display unit 202 of the HMD 100). For example, the PC control unit 211 acquires thumbnails of posted images from the SNS server 200 via the communication unit 214, generates video data of the list screen in which the acquired thumbnails are arranged, and transmits the video data of the list screen to the HMD 100.

In step S302, the PC control unit 211 determines whether a browsing operation of selecting any of one or a plurality of images (thumbnails) displayed on the list screen is performed. The PC control unit 211 waits for the browsing operation to be performed, and upon determining that the browsing operation is performed, the processing proceeds to step S303. The browsing operation is, for example, a user operation of pressing a predetermined button (a determination button) of the controller 120 while the position of a selected thumbnail is instructed by the controller 120. The browsing operation is not particularly limited and may be a user operation of pressing a predetermined button of the controller 120 while the line of sight is directed to the selected thumbnail. The browsing operation may be an operation of maintaining a state in which the controller 120 instructs the position of the selected thumbnail or a state in which the line of sight is directed to the selected thumbnail for a predetermined amount of time.

In step S303, the PC control unit 211 sends a request via the communication unit 214 to the SNS server 200 to transmit the image corresponding to the thumbnail selected by the browsing operation in step S302. In response to the request, the SNS server 200 transmits the image (image data) corresponding to the thumbnail selected by the browsing operation in step S302 to the PC 110.

In step S304, the PC control unit 211 displays a browsing screen including the image received in step S303 on the display device connected to the PC 110 (in the present embodiment, the display unit 202 of the HMD 100). For example, the PC control unit 211 generates video data of the browsing screen and transmits the video data to the HMD 100.

In step S305, the PC control unit 211 determines whether a return operation of returning a display screen to a previous screen is performed. When the PC control unit 211 determines that the return operation is performed, the processing proceeds to step S301, and otherwise, the processing proceeds to step S306. The return operation is, for example, a user operation of pressing a predetermined button (a return button) of the controller 120. The return operation is not particularly limited. For example, the browsing screen may include an item for the return operation, and the return operation may be a user operation of specifying (selecting) the item, similarly to the browsing operation.

In step S306, the PC control unit 211 determines whether a space display operation (a virtual reality (VR) display operation) of displaying a video of the virtual space such as the digital twin space or another metaverse space is performed. When the PC control unit 211 determines that the space display operation is performed, the processing proceeds to step S307, and otherwise, the processing proceeds to step S305. The space display operation is, for example, a user operation of pressing a predetermined button (a VR button) of the controller 120. The space display operation is not particularly limited. For example, the browsing screen may include an item for the space display operation, and the space display operation may be a user operation of specifying (selecting) the item, similarly to the browsing operation.

In step S307, the PC control unit 211 determines whether the display device connected to the PC 110 is an HMD. When the PC control unit 211 determines that the display device connected to the PC 110 is an HMD, the processing proceeds to step S308, and otherwise (for example, when the display device connected to the PC 110 is a normal PC monitor), the processing proceeds to step S305. The video display of the virtual space is suitably performed by the HMD. By the processing in step S307, a display device that performs the video display of the virtual space can be limited to the HMD. As the determination in step S307, it may be determined whether the display device connected to the PC 110 is a mobile device. Accordingly, the display device that performs the video display of the virtual space can include a smartphone or a tablet terminal.

In step S308, the PC control unit 211 acquires position information (for example, information indicating the capturing position of an image) associated with the image (the image on the browsing screen) received in step S303. For example, in step S303, image data to which the position information is added as metadata is received, and in step S308, the metadata is acquired (extracted) from the image data. In step S303, image data to which position information is not added may be received, and in step S308, the position information may be acquired from the SNS server 200 via the communication unit 214.

In step S309, the PC control unit 211 determines whether the image received in step S303 (the image on the browsing screen) is a specific image satisfying at least one of the following conditions. When the PC control unit 211 determines that the image received in step S303 is the specific image, the processing proceeds to step S305, and otherwise, the processing proceeds to step S310.
Condition 1: A person appears in the image.
Condition 2: Predetermined authorization is not given to use the image.
Condition 3: Position information of the image indicates a position outside a predetermined area.
Condition 4: The image is not an image of a real space.
Condition 5: The image is a moving image (is not a still image).

By the processing in step S309, a case of performing the video display of the virtual space is limited. According to Conditions 1 to 3, the privacy of the poster can be protected. For example, by applying Condition 1, it is possible to prevent another person from knowing the action of the poster in detail by video display of the virtual space in a state in which the poster is recognized. By applying Condition 2, the poster can select whether video display of the virtual space is enabled or disabled based on whether predetermined authorization is set to on or off. By applying Condition 3, it is possible to limit an area in which video display of the virtual space is possible to an area registered in advance in the SNS server 200 by a tourist association or the like.

When Condition 1 is applied, it is necessary to detect a person in an image. A method of detecting a person in an image is not particularly limited, and various existing methods can be used. A person satisfying a condition that the person's image size is equal to or greater than a threshold value, a condition that the person is located in the center of the image, or the like may be detected as a main object. Therefore, Condition 1 may be a condition that the image is an image in which a person appears as the main object. When a face image of the poster is registered in advance in the SNS server 200 or the like, it is possible to detect only the poster in the image. Therefore, Condition 1 may be a condition that the image is an image in which the poster is captured.

When Condition 2 is applied, the predetermined authorization may be information that can be given only by a user of a store account or a specific poster (a predetermined person) such as an influencer. Accordingly, it is possible to protect the privacy of a general user. The predetermined authorization may be the position information acquired in step S308. Here, when the acquisition of the position information fails in step S308, Condition 2 is satisfied in step S309. Condition 2 may be a condition that the image is associated with information indicating that video display of the virtual space is not permitted.

In step S310, the PC control unit 211 sends a request via the communication unit 214 and the SNS server 200 to the virtual space server 300 to transmit data in a range of a predetermined size including a position corresponding to the position information acquired in step S308 as virtual space data. The range of the predetermined size is, for example, a hemispherical (dome-shaped) range centered on the position corresponding to the position information acquired in step S308. In response to the request, the virtual space server 300 transmits the virtual space data (data in the range of the predetermined size) to the PC 110 via the SNS server 200. The data of the entire virtual space may be transmitted, or the amount of data transmission may be reduced by limiting the virtual space data to data in the range of the predetermined size.

In step S311, the PC control unit 211 determines whether the virtual space data is successfully received. When the PC control unit 211 determines that the virtual space data is successfully received, the processing proceeds to step S312, and otherwise, the processing proceeds to step S305. Reception of data of the virtual space may fail depending on the connection state between the PC 110, the SNS server 200, and the virtual space server 300. When virtual space data not stored in the virtual space server 300 is requested, the processing in step S311 is performed, the reception of virtual space data fails, and the processing proceeds to step S305.

Note that, when the virtual space data is prepared in advance in the recording medium 215 of the PC 110 or the like, the processing in step S310 and step S311 may be omitted.

In step S312, the PC control unit 211 displays the virtual space video from a viewpoint of the position corresponding to the position information acquired in step S308 on the display device connected to the PC 110 (in the present embodiment, the display unit 202 of the HMD 100) based on the virtual space data received in step S311. For example, the PC control unit 211 generates video data of the virtual space and transmits the video data to the HMD 100.

While the virtual space video is displayed, the user wearing the HMD 100 can face rightward and view a right range not drawn in the image received in step S303 (the image on the browsing screen). Similarly, the user can face leftward, upward, or downward and view a leftward, upward, or downward range not drawn in the image received in step S303. The user can move in the virtual space by performing a movement operation of the user moving themselves (viewpoint). As such, the user can easily obtain information on a portion not drawn in an image (for example, a portion not shown in a photograph). When the virtual space is the digital twin space, the image received in step S303 is displayed, and the position information acquired in step S308 indicates the capturing position of the image received in step S303, the user can experience as if the user is at the capturing position by the video display of the virtual space.

In step S313, the PC control unit 211 determines whether a return operation of returning the display screen to a previous screen is performed. When the PC control unit 211 determines that the return operation is performed, the processing proceeds to step S304, and otherwise, the processing proceeds to step S314. The return operation is, for example, a user operation of pressing a predetermined button (a return button) of the controller 120. The return operation is not particularly limited. For example, an item for the return operation may be displayed along with the virtual space video, and the return operation may be a user operation of specifying (selecting) the item, similarly to the browsing operation.

In step S314, the PC control unit 211 determines whether a movement operation of moving a viewpoint is performed. The PC control unit 211 waits for the movement operation to be performed and proceeds to step S315 upon determining that the movement operation is performed. When the movement operation is not performed, the PC control unit 211 proceeds to step S313. The movement operation is, for example, a user operation of moving a predetermined stick (a moving stick) of the controller 120 in a desired direction such as an upward (backward) direction, a downward (forward) direction, a leftward direction, or a rightward direction. The movement operation is not particularly limited. For example, an item for the movement operation may be displayed along with the virtual space video, and the movement operation may be a user operation of specifying (selecting) the item, similarly to the browsing operation.

In step S315, the PC control unit 211 sends a request via the communication unit 214 and the SNS server 200 to the virtual space server 300 to transmit data in a range of a predetermined size including the position after movement according to the movement operation in step S314 as the virtual space data. In response to the request, the virtual space server 300 transmits the virtual space data (data in the range of the predetermined size) to the PC 110 via the SNS server 200.

In step S316, the PC control unit 211 displays the virtual space video from the viewpoint of the position after the movement operation in step S314 on the display device connected to the PC 110 (in the present embodiment, the display unit 202 of the HMD 100) based on the virtual space data received in step S315.

Note that the processing of the PC 110 may be changed as appropriate, and for example, at least one of steps S306 to S308 may be omitted. In response to a user operation of selecting an image on the list screen without displaying the browsing screen, the display on the HMD 100 may be switched from the display of the list screen to the display of the virtual space video. A function of displaying the virtual space video may or may not be a part of a function of the SNS application. When a VR application that displays the virtual space video is an application different from the SNS application, the SNS application and the VR application perform the processing of FIG. 3 by cooperating with each other. For example, when the processing proceeds to step S310, the SNS application activates the VR application.

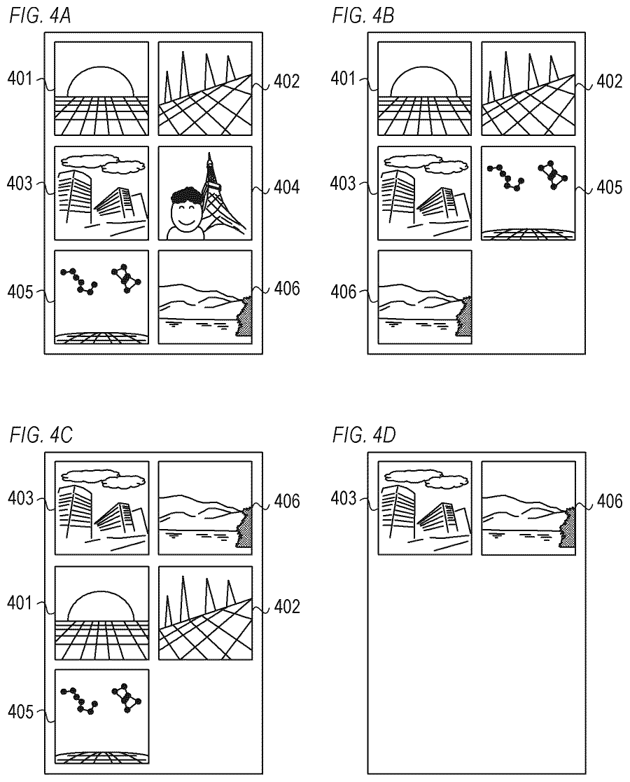

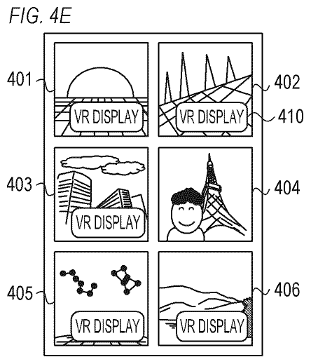

FIG. 4A is a schematic diagram illustrating an example of the list screen displayed in step S301 of FIG. 3. On the list screen in FIG. 4A, the thumbnails of the plurality of posted images are arranged. Here, the number of posted images is not particularly limited, but for simple description, it is assumed that six images are posted by different users. On the list screen in FIG. 4A, six thumbnails 401 to 406 respectively corresponding to the six images are displayed. The thumbnails 401, 402, and 405 are thumbnails corresponding to images (still images) in the virtual space, and the thumbnails 403, 404, and 406 are thumbnails corresponding to still images in the real space. The image of the virtual space is, for example, an image obtained as a screenshot of a virtual space video, an image captured by a virtual camera, or the like. The list screen may include thumbnails of a moving image of the real space, a moving image of the virtual space, an illustration, an animation, and the like.

The PC control unit 211 may select and set one of a plurality of display modes on the list screen in response to a user operation or the like. The plurality of display modes include a mode of displaying a list screen indicating both images that are triggers for video display of a virtual space and images that are not triggers for video display of a virtual space, and a mode of displaying a list screen indicating only images that are triggers for video display of a virtual space.

Here, it is assumed that only Condition 1 is applied in step S309 of FIG. 3. Here, the list screen in FIG. 4A shows images that are triggers and an image that is not a trigger. The thumbnail 404 is a thumbnail of an image in which a poster is captured and is therefore the image that is not the trigger. The thumbnails 401 to 403, 405, and 406 are thumbnails of images each of which is a trigger. Therefore, when the mode for displaying the list screen indicating only images that are triggers is set, the list screen in FIG. 4B is displayed in step S301 of FIG. 3. The list screen in FIG. 4B does not include the thumbnail 404 and includes the thumbnails 401 to 403, 405, and 406. According to the list screen in FIG. 4B, the user can easily select an image that is a trigger for video display of a virtual space.

As illustrated in FIG. 4C, in the mode of displaying the list screen indicating only images that are triggers, the PC control unit 211 may determine the arrangement order of the plurality of images (the plurality of thumbnails) on the list screen so that images of a real space are arranged before images of a virtual space. As illustrated in FIG. 4D, in the mode of displaying the list screen indicating only images that are triggers, the PC control unit 211 may adopt the list screen indicating only images of a real space. According to the list screens in FIGS. 4C and 4D, the user can easily select an image of a real space that is a trigger for video display of a virtual space.

As illustrated in FIG. 4E, the list screen may include an item 410 associated with each image (thumbnail) that is a trigger. The item 410 is a button for starting video display of the virtual space. Note that the mode or the position of the item 410 is not particularly limited. The item 410 may also be displayed on the list screen displaying only images that are triggers. In response to a user operation of specifying (selecting) the item 410, the PC control unit 211 may perform control for displaying the virtual space video based on the image associated with the item 410 on the display unit 202. For example, after displaying the list screen on the display unit 202 in step S301 of FIG. 3, the PC control unit 211 may proceed to step S306 in response to the user operation of designating the item 410. In a situation in which the virtual space video is not displayed, similarly to a situation in which the display device connected to the PC 110 is not an HMD, the PC control unit 211 may not display the item 410 on the list screen or may display the item in a disabled state (for example, grayed out). Accordingly, it is possible to prevent the user from specifying (selecting) the item 410 when the virtual space video can not be displayed.

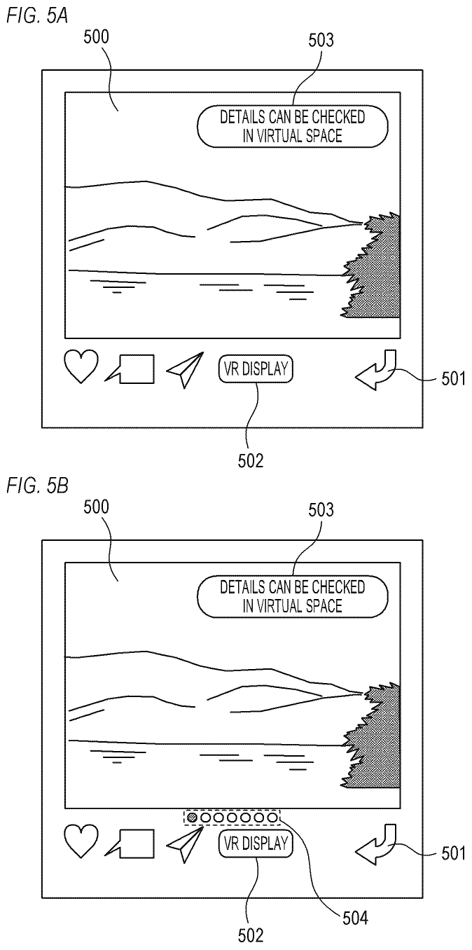

FIG. 5A is a schematic diagram illustrating an example of the browsing screen displayed in step S304 of FIG. 3. The browsing screen in FIG. 5A includes a selected image 500 and items 501 to 503. Although detailed description is omitted, the browsing screen in FIG. 5A also includes items corresponding to various functions often used in SNS. For example, in addition to the items 501 to 503, items such as a “like” button indicating an intention to like, enjoy, and support posted content, a comment button to comment on the post, and a share button to share the post to another SNS are included.

As illustrated in FIG. 5B, when a plurality of images are included in one post, an item 504 indicating which image is currently displayed is included. FIG. 5B illustrates an example in which one post includes seven images. The item 504 includes seven circles (dots) respectively corresponding to the seven images, and the circle corresponding to an image being displayed is displayed in a different mode (different color, luminance, and the like) from modes of the six circles respectively corresponding to the remaining six images. The user can switch the image being displayed among the plurality of images by a user operation such as touching a circle, gazing at a circle, or pressing a direction key of the controller 120. Note that, when one image is included in one post, an item indicating which image is currently displayed is not included.

The item 501 is a button for the return operation in step S305, and the items 502 and 503 are buttons for the space display operation in step S306. Note that the mode or the position of each of the items 501 to 503 is not particularly limited. After displaying the browsing screen on the display unit 202 in step S304, the PC control unit 211 proceeds the processing to step S301 in response to the user operation of specifying (selecting) the item 501 in step S305. The PC control unit 211 proceeds the processing to step S307 in response to the user operation of specifying (selecting) the item 502 or the item 503. In a situation in which the virtual space video is not displayed, similarly to a situation in which the display device connected to the PC 110 is not an HMD, the PC control unit 211 may not display the items 502 and 503 on the browsing screen or may display the items in a disabled state (for example, grayed out). Accordingly, it is possible to prevent the user from specifying (selecting) the items 502 and 503 when the virtual space video can not be displayed.

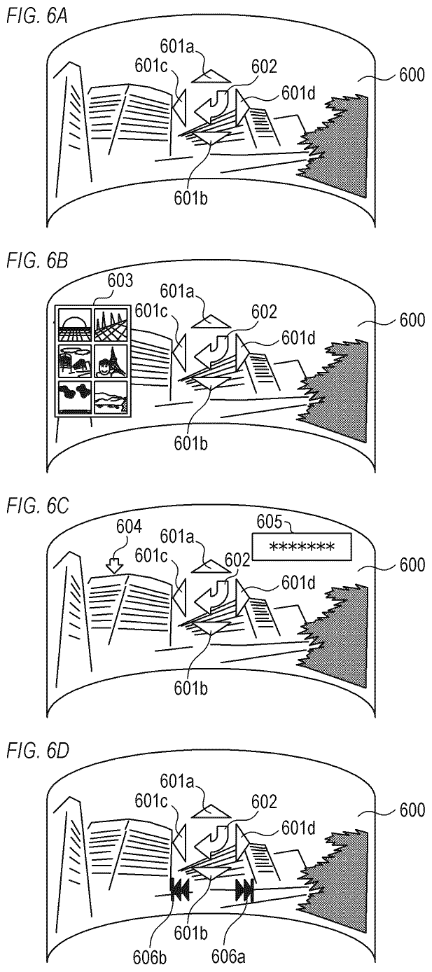

FIG. 6A is a schematic diagram illustrating an example of the virtual space video displayed in step S312 of FIG. 3. In FIG. 6A, items 601a to 601d and 602 are displayed along with a virtual space video 600. As described above, it is assumed that a range of the virtual space video 600 changes depending on a change in the orientation of the HMD 100 (a change in the direction of the face of the user wearing the HMD 100), but the positions of the items 601a to 601d and 602 relative to the virtual space video 600 are fixed. The items 601a to 601d are buttons for the movement operation in step S314, and the item 602 is a button for the return operation in step S313. Note that the mode or the position of each of the items 601a to 601d and 602 is not particularly limited.

After displaying the virtual space video 600 on the display unit 202 in step S312, the PC control unit 211 proceeds with the processing to step S315 in response to the user operation of specifying (selecting) the item 601a, the item 601b, the item 601c, or the item 601d. The viewpoint is moved forward when the item 601a is specified, the viewpoint is moved backward when the item 601b is specified, the viewpoint is moved leftward when the item 601c is specified, and the viewpoint is moved rightward when the item 601d is specified. The PC control unit 211 proceeds the processing to step S304 in response to the user operation of specifying (selecting) the item 602 in step S313.

As illustrated in FIG. 6B, the PC control unit 211 may display an item 603 indicating the presence of a post on the display unit 202 along with the virtual space video 600. The item 603 is a virtual window of the list screen. Accordingly, the user can grasp the presence of a post corresponding to the periphery of a current location in the virtual space. Similarly to steps S301 to S312 in FIG. 3, when an image is selected from the item 603 (the virtual window of the list screen), the PC control unit 211 may cause the virtual space video 600 to transition to a video of a viewpoint based on the selected image. Accordingly, convenience is further improved. Here, the user obtains a feeling as if they teleported into the virtual space.

The mode or the position of the item indicating the presence of a post is not particularly limited, and for example, as illustrated in FIG. 6C, an item 604 (an icon) indicating the presence of a post may be displayed at a position corresponding to position information of the post. Accordingly, the user can move to the position corresponding to the position information of the post depending on the item 604. The PC control unit 211 may shift the viewpoint to the position of the item 604 in response to a user operation of specifying (selecting) the item 604. Accordingly, convenience is further improved.

A real space or a virtual space may be divided into a plurality of areas in advance, and an advertisement may be associated with each area in advance. Then, as illustrated in FIG. 6C, the PC control unit 211 may display an advertisement 605 on the display unit 202 based on the position information acquired in step S308 along with the virtual space video 600. The advertisement 605 is an advertisement associated with an area in the real space including a position indicated by the position information, or an advertisement associated with an area in the virtual space including a position (a viewpoint) corresponding to the position information. Accordingly, the user can easily obtain information on the current viewpoint (for example, information on surrounding facilities, and the like) from the advertisement 605. An advertisement fee may be paid to a poster of the selected image or may be paid to a service provider of the SNS or the virtual space.

As described above, according to the present embodiment, position information associated with an image selected by a user is acquired, and a video of the virtual space viewed from a position corresponding to the position information is displayed on a display device. Accordingly, a user can easily obtain information on a portion not drawn in an image (for example, a portion not shown in a photograph).

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

For example, an example in which an image posted on the SNS is selected is described, but the present disclosure is not limited thereto. For example, there is a case in which a user stores an image captured by the user themselves in the recording medium 215 and checks the image later, but the user may not be able to remember details of the portions not shown in the image. Therefore, the present disclosure is also applicable to a case in which an image stored in the recording medium 215 is selected.

An example in which the video display of the virtual space is not performed when a moving image is selected is described, but the video display of the virtual space may also be performed when a moving image is selected. When a moving image is selected, the PC control unit 211 may acquire position information representing the moving image as position information associated with the moving image. The position information representing the moving image is, for example, position information corresponding to a thumbnail of the moving image, position information corresponding to a first frame of the moving image, position information of a characteristic object (a landmark) shown in the moving image, and the like.

When a moving image including a plurality of scenes (a combined moving image obtained by connecting a plurality of moving images) is selected, the PC control unit 211 may acquire a plurality of pieces of position information respectively corresponding to the plurality of scenes as position information associated with the moving image. Here, the PC control unit 211 displays a virtual space video from a viewpoint of a position corresponding to any one of the plurality of pieces of position information on the display unit 202. In response to a user operation of switching a viewpoint of the virtual space video, the PC control unit 211 may switch a viewpoint between a plurality of positions respectively corresponding to the plurality of pieces of position information. Accordingly, convenience is further improved.

When a post (image content) posted on the SNS and including images of a plurality of places separated by a distance farther than a predetermined distance is selected, the PC control unit 211 may display a virtual space video corresponding to the selected place among the plurality of places on the display unit 202. The post posted on the SNS and including the images of the plurality of places separated by a distance farther than the predetermined distance is, for example, a post that is a list of recommended restaurants serving dishes of the same genre, a post that is a list of representative attraction spots in each country (each prefecture), or the like. In such a post, a virtual space video based on position information of an image displayed at a timing when the VR display (the item 502) is selected may be displayed. When the user browses an image related to a place of interest among the plurality of places, the user can select the VR display (the item 502) to transition the displayed image to a virtual space video related to the image that the user themselves viewed. In response to selection of the VR display (the item 502), not only an image displayed at the timing when the VR display (the item 502) is selected but also a plurality of images of one post may be displayed, and the user may be allowed to select a desired image among the plurality of images and display a virtual space video related to the selected image. As such, when there is an image of any place of interest after viewing all the images once, the user can select the display of the virtual space video related to a desired image by selecting the image.

The user operation of switching the viewpoint is not particularly limited and may be or may not be a user operation of pressing a predetermined button (a viewpoint switching button) of the controller 120. As illustrated in FIG. 6D, the PC control unit 211 may display items 606a and 606b for switching the viewpoint on the display unit 202 along with the virtual space video 600. Here, in response to a user operation of specifying (selecting) the item 606a, the PC control unit 211 switches the viewpoint to a position next to a current viewpoint in a predetermined arrangement order (for example, a scene order) among the plurality of positions respectively corresponding to the plurality of pieces of position information. In response to a user operation of specifying (selecting) the item 606b, the PC control unit 211 switches the viewpoint to a position immediately before the current viewpoint in a predetermined arrangement order among the plurality of positions respectively corresponding to the plurality of pieces of position information.

According to the present disclosure, a user can easily obtain information on a portion not drawn in an image (for example, a portion not shown in a photograph).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-226484, filed Dec. 23, 2024, the entirety of which is incorporated herein by reference.

What is claimed is:

1. An electronic device comprising:
a processor; and
a memory storing a program which, when executed by the processor, causes the electronic device to:
execute acquisition processing of acquiring position information associated with an image selected by a user from among one or more images; and
execute control processing of performing control so that a video of a virtual space having a viewpoint from a position corresponding to the position information is displayed on a display device in a case where the position information is acquired by the acquisition processing, wherein
in the control processing,
control is performed to display on the display device a list screen of the one or more images or a browsing screen of the image selected by the user, and
control is performed in response to a first user operation while the list screen or the browsing screen is displayed so that display on the display device is switched from display of the list screen or the browsing screen to display of the video of the virtual space.

2. The electronic device according to claim 1, wherein
the one or more images are posted images.

3. The electronic device according to claim 1, wherein,
in a case where the position information is acquired by the acquisition processing, in the control processing, control is performed to acquire data of a range having a predetermined size including the position corresponding to the position information as data of the virtual space and to display the video of the virtual space on the display device based on the acquired data.

4. The electronic device according to claim 1, wherein
in a case where the display device is a head-mounted display device, in the control processing, control for displaying the video of the virtual space on the display device is performed, and in a case where the display device is not a head-mounted display device, control for displaying the video of the virtual space on the display device is not performed.

5. The electronic device according to claim 1, wherein
the virtual space is a three-dimensional space in which a real space is reproduced.

6. The electronic device according to claim 1, wherein
in a case where the list screen is displayed, in the control processing, a display target is selected from a plurality of list screens including a first list screen and a second list screen, the first list screen showing one or more images that are triggers of video display of the virtual space and one or more images that are not triggers of video display of the virtual space, and the second list screen showing only the one or more images that are triggers of video display of the virtual space.

7. The electronic device according to claim 6, wherein
in a case where the second list screen showing an image obtained by capturing a real space and an image obtained by capturing the virtual space is displayed, in the control processing, an arrangement order of a plurality of images shown in the second list screen is determined so that the image obtained by capturing the real space is arranged before the image obtained by capturing the virtual space.

8. The electronic device according to claim 6, wherein
the second list screen shows only one or more images obtained by capturing a real space.

9. The electronic device according to claim 1, wherein
in a case where the user selects an image in which a person is captured, an image for which predetermined authorization is not given, an image that is not an image obtained by capturing a real space, or a moving image, in the control processing, control for displaying the video of the virtual space on the display device is not performed.

10. The electronic device according to claim 1, wherein
in a case where the user selects an image for which the associated position information acquired by the acquisition processing indicates a position outside a predetermined area, in the control processing, control for displaying the video of the virtual space on the display device is not performed.

11. The electronic device according to claim 1, wherein
in a case where a moving image is selected by the user, in the acquisition processing, position information corresponding to a thumbnail of the moving image, position information corresponding to a first frame of the moving image, or position information of a characteristic object shown in the moving image is acquired as position information associated with the moving image.

12. The electronic device according to claim 1, wherein
in a case where a moving image including a plurality of scenes is selected by the user, in the acquisition processing, a plurality of position information respectively corresponding to the plurality of scenes are acquired, and
in a case where the plurality of position information are acquired by the acquisition processing, in the control processing, control is performed to display on the display device a video of the virtual space having a viewpoint from a position corresponding to any one of the plurality of position information.

13. The electronic device according to claim 12, wherein
in a case where the plurality of position information are acquired by the acquisition processing, in the control processing, the viewpoint is switched between a plurality of positions respectively corresponding to the plurality of position information in response to a second user operation.

14. The electronic device according to claim 13, wherein
in a case where the plurality of position information are acquired by the acquisition processing, in the control processing, control is performed so that a first item is displayed on the display device along with the video of the virtual space having the viewpoint from the position corresponding to any one of the plurality of position information, and
the second user operation includes a user operation of selecting the first item.

15. The electronic device according to claim 1, wherein
the browsing screen includes a second item, and
the first user operation includes a user operation of selecting the second item.

16. The electronic device according to claim 1, wherein
the list screen includes a third item associated with an image on the list screen, and
the first user operation includes a user operation of selecting the third item.

17. The electronic device according to claim 1, wherein
after the display on the display device is switched from display of the list screen or the browsing screen to display of the video of the virtual space, in the control processing, control is performed in response to a third user operation so that the display on the display device returns from the display of the video of the virtual space to the display of the list screen or the browsing screen displayed before switching to the display of the video of the virtual space.

18. The electronic device according to claim 1, wherein
in the control processing, control is performed so that an advertisement associated with an area including a position indicated by the position information or an area including the viewpoint is displayed on the display device along with the video of the virtual space.

19. A control method of an electronic device, comprising:
performing control to display on a display device a list screen of one or more images or a browsing screen of an image selected by a user from among the one or more images;
acquiring position information associated with the image selected by the user; and
performing control in response to a predetermined user operation while the list screen or the browsing screen is displayed so that display on the display device is switched from display of the list screen or the browsing screen to display of a video of a virtual space having a viewpoint from a position corresponding to the position information, in a case where the position information is acquired.

20. A non-transitory computer readable medium that stores a program, wherein the program causes a computer to execute a control method of an electronic device, the control method comprising:
performing control to display on a display device a list screen of one or more images or a browsing screen of an image selected by a user from among the one or more images;
acquiring position information associated with the image selected by the user; and
performing control in response to a predetermined user operation while the list screen or the browsing screen is displayed so that display on the display device is switched from display of the list screen or the browsing screen to display of a video of a virtual space having a viewpoint from a position corresponding to the position information, in a case where the position information is acquired.
